(19) United States
(12) Patent Application Publication
(10) Pub. No.: US 2006/0030986 A1
(43) Pub. Date: Feb. 9, 2006

(54) Audio-video vehicle trip recording apparatus

(76) Inventor: Kuei-Snu Peng, Xihu Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/076,958

(22) Filed: Mar. 11, 2005

(30) Foreign Application Priority Data
Jul. 13, 2004 (TW) 093210981

(51) Int. Cl. G06F 19/00

(52) U.S. Cl. 701/35

(57) ABSTRACT

The present invention discloses an audio-video vehicle trip recording apparatus that receives the action signals of vehicle and audio-video signals. After processing by the main processor, the diagrammatic symbol, character and number can be integrated into the image signals to store the trip status in the memory. When playing the file later, the image, voice and vehicle action signals can be read out together. Hence, the present invention provides an audio-video recording apparatus that can completely record the trip status to ensure driver's rights and interests.

### BACKGROUND OF INVENTION

1. Field of the Invention

The invention relates to a recording apparatus, and more particularly, to a vehicle trip recording apparatus that can record the audio-video environment and the vehicle data.

2. Description of the Prior Art

The vehicle trip recording apparatus is a digital electronic recording apparatus installed on vehicles to record, storage, display and print out the information of speed, time, mileage, and other environment related to the vehicle. With these records, a scientific management platform and an intelligent management model can be provided to the vehicle management to efficiently record the driver's behavior and the accident process. The quantified management and scientific monitor of vehicle trip situation can provide detailed and accurate information.

One kind of conventional vehicle trip recording apparatus is disclosed in Taiwan Patent Application 86210305, “digital vehicle accident recording device”, which records the image data of accident taken in driving. But this device fails to record the controlled situations, such as light, speed, brake, turning direction, of the vehicle while accident occurs, and the mighty evidence cannot be provided to verify the accident responsibility.

Another kind of vehicle trip recording apparatus is disclosed in Taiwan Patent Application 86220237, “vehicle trip recording device”, which records the vehicle data of driving. But this device fails to record the audio-video information of external environment, and cannot be used to verify the responsibility of accident. In addition, this device must be connected to many locations of the vehicle to collect the vehicle data in driving that increases the installation cost.

Hence, the present invention provides an audio-video vehicle trip recording apparatus to simultaneously record the driving information and the environment images and sound to effectively manage the vehicle trip information.

### SUMMARY OF INVENTION

It is therefore a primary objective of the claimed invention to provide an audio-video vehicle trip recording apparatus that can simultaneously record the driving information and the environment images and sound to provide accurate vehicle trip record after analyzed by computer software.

It is therefore another objective of the claimed invention to provide an audio-video vehicle trip recording apparatus that utilizes the originally existed car monitor to immediately display the vehicle trip information without extra expensive equipments.

It is therefore a further objective of the claimed invention to provide an audio-video vehicle trip recording apparatus that uses the standard communication interface to transmit data with high safety and comparability.

It is therefore a further objective of the claimed invention to provide an audio-video vehicle trip recording apparatus that utilizes the integrated design to decrease the manufacture cost and contracts the scale to make installing in the limited vehicle space easy.

According to the claimed invention, the audio-video vehicle trip recording apparatus connects several cameras and pickups, connects the vehicle computer communication port via a communication interface, and connects the vehicle electrical and mechanical devices via an input interface. With this connection hypothesis, the apparatus can receive the audio signal, video signal and vehicle action signal, and the main processor can store all these signals. The vehicle trip record can be directly read out by the vehicle audio-video devices or can be transmit to an external computer via the transmitting interface to precisely distinguish the vehicle signals. The precise recorded data can be powerful evidences in a vehicle accident, and furthermore the apparatus is integrated that can decrease the size and simplify the installation.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of the present invention.

| | | | |
|---|---|---|---|
| 10 | vehicle trip recording | 12 | external computer |
| | apparatus | | |
| 18 | vehicle trip computer | 20 | main processor |
| 22 | input interface | 24 | communication interface |
| 26 | memory | 28 | data transmitting interface |
| 29 | operation panel | 111 | car monitor |
| 112 | car audio | 141 | front camera |
| 142 | rear camera | 143 | vehicle space pickup |

### DETAILED DESCRIPTION

The present invention utilizes the input interface and the communication interface to receive the vehicle trip data, and combines the vehicle trip data with the outside vehicle images and the inside vehicle voice via a main processor, so that the driving status can be precisely retained.

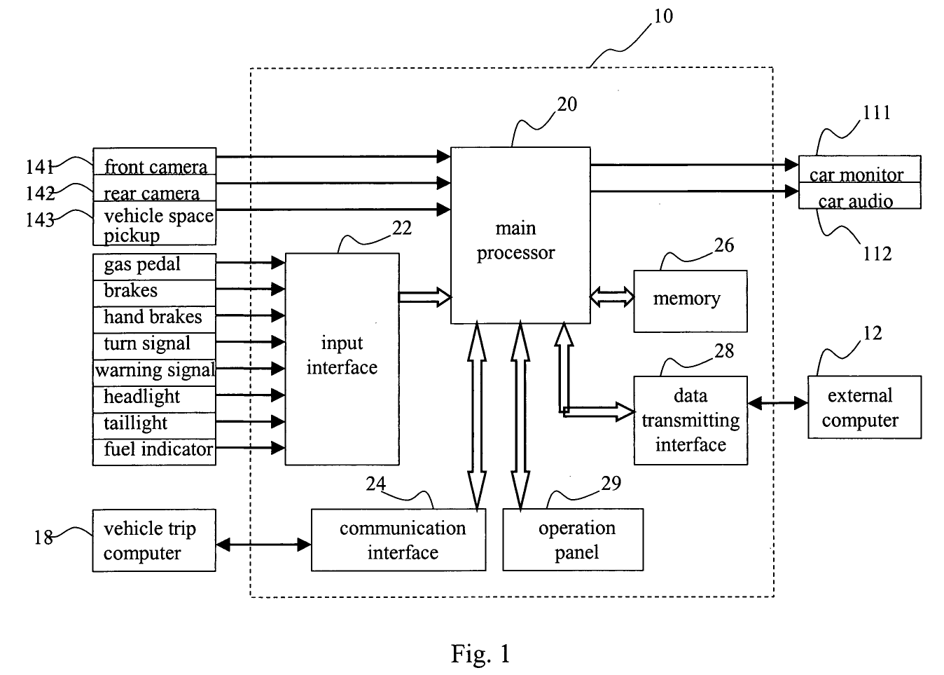

Please refer to FIG. 1, which is a block diagram of the present invention. The vehicle trip recording apparatus 10 includes a main processor 20 for processing digital signals, an input interface 22 for receiving the action signals of the electrical and mechanical devices and transmitting to the main processor 20, a communication interface 24, generally being a RS-232 interface, for receiving the vehicle trip information of a vehicle computer 18 and transmitting to the main processor 20, a memory 26 for providing data storage while the main processor 20 operating, a data transmitting interface 28 for transmitting data to an external computer 12. Wherein, the main processor 20 is connected to several external devices including a front camera 141 for receiving images in front of the car, a rear camera 142 for receiving images behind the car, a vehicle space pickup 143 for receiving voice of circumstance, and a car monitor 111 and a car audio 112 for showing the recorded vehicle trip signals. The vehicle trip recording apparatus 10 further has an operation panel 29 connecting to the main processor 20 for providing the control interface of the vehicle trip recording apparatus 10.

In addition, the input interface 22 is connected to the electrical and mechanical devices of the vehicle including gas pedal, brakes, hand brakes, turn signal, warning signal, headlight, taillight, low fuel indicator, oil pressure indicator and high temperature indicator. The vehicle trip information of a vehicle computer 18 generally includes ABS action, front or rear collision, airbag trigger, gas pedal, normal turn, unusual wide turn in high speed, vehicle speed, water temperature, and oil pressure.

When the car is driven, the front camera 141 and the rear camera 142 shoot images in front of and behind the car, transfer to video signals, and transmit to the main processor 20. The vehicle space pickup 143 receives voice inside the car, transfers to the audio signals, and transmits to the main processor 20. The main processor 20 receives the video and audio signals as one part of the vehicle trip record. The input interface 22 receives the switching signal or the voltage change signal of the electrical and mechanical devices, and transfers the signals to the Transistor-Transistor Logic (TTL) level signal to the main processor 20 as another part of the vehicle trip record. The communication interface 24 connects the main processor 20 and a vehicle computer 19 to read out the vehicle trip information as a further part of the vehicle trip record.

When the vehicle trip recording apparatus 10 begins to record the vehicle trip status, users can operate the operation panel 20 to show the recorded vehicle trip record. The main processor 20 can transmit the audio-video information to the car monitor 111 and the car audio 112 to completely display the recorded diagrammatic symbol, character, number, image and voice. In case of interception by police for over the speed limit, the recorded file can be immediately played to verify the vehicle speed. In case of collision, the recorded file can be played to identify the brake or gas pedestal condition. In case of pileup, the recorded file can be checked to verify if the front car hits the car before it first and our car then hits the front car, or our car hits the front car first and the front car then hits the car before it. In these mentioned situations, the vehicle trip record can be copied as distinct reference or evidence of traffic accident.

The data transmitting interface 28 can transmit the recorded vehicle file to the external computer 12. After analyzing by software, the precise vehicle trip record can be obtained to mark out the critical point and produce a time-action diagram to verify the accident responsibility. Additionally, the vehicle trip recording apparatus 10 can be also used to manage the drivers of public bus or truck. The vehicle trip file can be transmitted to a memory card via the data transmitting interface 28, and the drivers can take the memory card to a specific computer or a data collection station to store the files after leaving the cars. After analyzing by the software, the management information, such as driving hour or driving speed, can be easily obtained.

The present invention utilizes the main processor as core component of the vehicle trip recording apparatus. The main processor can receive the image signal, voice signal, vehicle action signal, and vehicle status signal, and integrate the signals to a vehicle trip file. This trip file includes images and all mentioned signals that can be surveyed as reference or evidence of traffic accident, or can be analyzed by software to produce the time-action diagram to verify the accident responsibility. Hence, the present invention not only can effectively solve the shortcomings of conventional technology that cannot record the detail controlled status of car while driving but also provides an audio-video recording apparatus that can completely record the trip status to ensure driver's rights and interests.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An audio-video vehicle trip recording apparatus, comprising:
an input interface having a plurality of action signal inputting ports to receive a plurality of vehicle action signals;
at least one communication interface connecting to at least one vehicle computer to receive vehicle status signals from the vehicle computer;
a main processor capable of receiving an external video signal and an audio signal, the video signal, the audio signal, the vehicle status signal and the vehicle action signals are processed in the main processor, and an audio-video signal and a plurality of recording files are output for displaying and storing; and
a data transmitting interface providing the recording files to an external device.

2. The audio-video vehicle trip recording apparatus of claim 1, wherein further comprises at least one memory.

3. The audio-video vehicle trip recording apparatus of claim 1, wherein further comprises an operation panel.

4. The audio-video vehicle trip recording apparatus of claim 1, wherein further comprises an audio-video outputting port.

5. The audio-video vehicle trip recording apparatus of claim 1, wherein the external device is selected from one of memory card and computer.

6. The audio-video vehicle trip recording apparatus of claim 1, wherein the input interface is a D/I input connecting port.

7. The audio-video vehicle trip recording apparatus of claim 1, wherein the communication interface is a RS-232 interface.

8. The audio-video vehicle trip recording apparatus of claim 1, wherein the action signals are produced by actions of the mechanical and electrical devices while driving, the mechanical and electrical devices is selected from at least one of gas pedal, brakes, hand brakes, turn signal, warning signal, headlight, taillight, low fuel indicator, oil pressure indicator and high temperature indicator.

9. The audio-video vehicle trip recording apparatus of claim 1, wherein subjects of the vehicle status signal is selected from at least one of ABS action, front or rear collision, airbag trigger, gas pedal, normal turn, unusual wide turn in high speed, vehicle speed, water temperature and oil pressure.

10. The audio-video vehicle trip recording apparatus of claim 1, wherein the video signals are inputted by a plurality of external cameras.

11. The audio-video vehicle trip recording apparatus of claim 10, wherein the cameras shoot images around the vehicle.

12. The audio-video vehicle trip recording apparatus of claim 1, wherein the audio signal is inputted by a voice receiver.

13. The audio-video vehicle trip recording apparatus of claim 12, wherein the voice receiver is a vehicle space pickup.

14. The audio-video vehicle trip recording apparatus of claim 1, wherein the main processor is designed with semiconductor circuits.

15. The audio-video vehicle trip recording apparatus of claim 1, wherein the external device is selected from one of memory card and computer.

16. The audio-video vehicle trip recording apparatus of claim 1, wherein the audio-video signal is transmitted to a car monitor and an audio.
